(19) United States
(12) Patent Application Publication
(10) Pub. No.: US 2026/0292957 A1
(43) Pub. Date: Sep. 24, 2026

(54) METHOD OF OPERATING AN OPTOELECTRONIC COMPONENT, METHOD OF MANUFACTURING AN OPTOELECTRONIC COMPONENT, OPTOELECTRONIC COMPONENT, AND ILLUMINATION DEVICE

(71) Applicant: ams-OSRAM International GmbH, Regensburg (DE)

(72) Inventors: Stefan Groetsch, Bad Abbach (DE); Igor Stanke, Regensburg (DE); Bilal Saif, Regensburg (DE); Markus Koesler, Landshut (DE); Christian Ziereis, Regensburg (DE)

(21) Appl. No.: 19/473,855

(22) PCT Filed: Apr. 10, 2024
(86) PCT No.: PCT/EP2024/059710

§ 371 Date: Oct. 9, 2025

(30) Foreign Application Priority Data
Apr. 12, 2023 (DE) 10 2023 109 138.7

(51) Int. Cl. H05B 47/105; B60Q 1/04; B60Q 11/00; G03B 21/16

(52) U.S. Cl. CPC H05B 47/105; G03B 21/16; B60Q 1/04; B60Q 11/005

(57) ABSTRACT

In an embodiment a method for operating an optoelectronic component includes starting up a pixel array, reading-out a first temperature using a temperature sensor simultaneously to the starting up of the pixel array, determining a first operation parameter of at least one of optoelectronic semiconductor chips of the pixel array, correlating the first temperature and the first operation parameter to establish a first data point, comparing the operation parameter and the first temperature to an operation model of the pixel array, updating the operation model when the operation parameter and the first temperature differ from the operation model by a preset first threshold, measuring operation parameters of the optoelectronic semiconductor chips of the pixel array and calculating a temperature using the operation model.

### CROSS-REFERENCE TO RELATED APPLICATIONS

This patent application is a national phase filing under section 371 of PCT/EP2024/059710, filed Apr. 10, 2024, which claims the priority of German patent application no. 10 2023 109 138.7, filed Apr. 12, 2023, each of which is incorporated herein by reference in its entirety.

### TECHNICAL FIELD

The present invention relates to a method of operating an optoelectronic component, a method of manufacturing an optoelectronic component, an optoelectronic component, and an illumination device.

### BACKGROUND

Optoelectronic components with pixel arrays and a driving circuit for the pixel array are known in the state of the art. Pixel arrays comprise an at least two-dimensional arrangement of optoelectronic semiconductor chips. In operation, these pixels may be driven individually, particularly allowing for an image projected by the pixel array. These pixel arrays may, for example, be used in automotive headlamps or active pixel projectors.

These optoelectronic components usually include a temperature sensor to monitor an operating temperature of the pixels of the pixel array. At a given maximum temperature partial damage of the pixel array could occur and therefore the power of the pixel array may be reduced when the temperature measured by the temperature sensor exceeds a certain value, which may be called shut-off temperature. However, due to thermal conductivity and the fact that heat is produced directly at pn-junctions of the pixels and needs to reach the temperature sensor, the shut-off temperature is smaller than the maximum temperature to allow for thermal equilibrium. For some operating parameters of the pixel array this might result in a decrease of power although the maximum temperature of the pn-junctions is not reached yet.

### SUMMARY

Embodiments provide an improved method of operating an optoelectronic component. Further embodiments provide an improved method of manufacturing an optoelectronic component. Yet other embodiments provide an improved optoelectronic component and an illumination device with such an optoelectronic component.

According to a first embodiment, the invention relates to a method of operating an optoelectronic component. The optoelectronic component at least comprises a pixel array with a plurality of optoelectronic semiconductor chips, a temperature sensor, and a driving circuit.

Particularly, the pixel array may include a great number pixels and therefore optoelectronic semiconductor chips. The number of pixels may be around 25.000 or even greater, particularly around 50.000 or even 100.000. Furthermore, the optoelectronic component may include other elements like a housing and/or a power supply. The temperature sensor is in thermal contact with the pixel array. To operate the optoelectronic component the steps explained in the following are executed. Initially, the pixel array is started up. Simultaneously to the starting up of the pixel array a first temperature is read-out using the temperature sensor. Simultaneously in this context may include within a predefined time-span, wherein the predefined time span may be some microseconds, particularly in the range of 50 microseconds, for example up to 20 microseconds. The predefined time span may be particularly chosen such that a heat generated by the semiconductor chip is still so low that a temperature of a pn-junction of semiconductor chip is still unchanged. Furthermore, a first operation parameter of at least one of the optoelectronic semiconductor chips of the pixel array is determined. Then, the first temperature and the first operation parameter are correlated to establish a first data point. As the temperature of a pn-junction of the semiconductor chip is still unchanged, the first data point may include the temperature of the first pn-junction and the first operation parameter. The operation parameter and the first temperature are compared to an operation model of the pixel array. If the operation parameter and the first temperature differ from the operation model by a preset first threshold, the operation model is updated. Then, operation parameters of the optoelectronic semiconductor chips of the pixel array are measured and a temperature is calculated using the operation model.

The operation model may include a regression or a formula which relates the operation parameter to the temperature of the pn-junction. The core idea of the method of operating the optoelectronic component is to update the operation model if the operation parameter and the first temperature differ from the operation model by a preset first threshold. If such an update has been performed, the temperature of the pn-junctions is calculated using the updated model. At every starting up of the pixel array, the operation model is checked and discrepancies may be considered in the operation model. Therefore, the temperature measurement of the pn-junctions is improved. The optoelectronic semiconductor chips may be emitters.

According to a second embodiment, the invention relates to an optoelectronic component. The optoelectronic component at least comprises a pixel array with a plurality of optoelectronic semiconductor chips, a temperature sensor, and a driving circuit. Particularly, the pixel array may include a great number pixels and therefore optoelectronic semiconductor chips. The number of pixels may be around 25.000 or even greater, particularly around 50.000 or even 100.000. Furthermore, the optoelectronic component may include other elements like a housing and/or a power supply. The temperature sensor is in thermal contact with the pixel array. The driving circuit is equipped to execute the method of operation as explained above. The driving circuit may comprise a central processing unit to execute the method steps. Additionally, the driving circuit may include a control for individually controlling the pixels of the pixel array, particularly by controlling voltage, current or power of the pixels individually.

According to a third embodiment, the invention relates to an illumination device with such an optoelectronic component. The illumination device may particularly be suited to work as an automotive headlamp or as an active pixel projector.

According to a fourth embodiment, the invention relates to a method of manufacturing an optoelectronic component. In this method, the pixel array, the driving circuit and the temperature sensor are provided in such a way that the temperature sensor is in thermal contact with the pixel array. Additionally, the model of the pixel array is established, regarding a relationship between the operation parameter and the minimal differential temperature. This model is then provided for the driving circuit.

In one embodiment of the method of operating the following steps are executed. The pixel array is turned off. After that, a preset time span is lapsed and the method waits upon lapse of that preset time span. Then, a second temperature is read-out using the temperature sensor. A second operation parameter of at least one of the optoelectronic semiconductor chips of the pixel array is determined. Particularly, the same optoelectronic semiconductor chip or the same optoelectronic semiconductor chips as for the determination of the first operation parameter may be used in this step. The second temperature and the second operation parameter are correlated to establish a second data point. The second operation parameter and the second temperature are compared to the operation model of the pixel array. If the operation parameter and the second temperature differ from the operation model by a preset second threshold, the operation model is updated.

The preset time span may be set in such a way that thermal equilibrium between the temperature sensor and the optoelectronic semiconductor chip or the optoelectronic semiconductor chips of the pixel array is reached. To determine the second operation parameter, the optoelectronic semiconductor chip or the optoelectronic semiconductor chips may be turned on again for a short amount of time, particularly for some milliseconds. With these additions to the method the operation model may be adjusted for low temperatures using the first operation parameters and for high temperatures using the second operation parameters. Therefore, an overall operation model is improved.

In one embodiment of the method of operating the preset time span is five seconds or less, particularly three seconds or less, particularly in the range of one to two seconds. This allows for thermal equilibrium of the pn-junctions and the temperature sensor.

In one embodiment of the method of operating the first threshold and the second threshold are identical. This allows for an improved determination of the operation model. The first threshold and/or the second threshold in all embodiments may include a temperature value. If the temperature determined by the operation model for a given operation parameter differs by more than this threshold temperature from the read out from the temperature sensor, the operation model is adjusted.

In one embodiment of the method of operating the optoelectronic semiconductor chip or the optoelectronic semiconductor chips of the pixel array are selected according to an illumination pattern of the pixel array. This selection may include selection of optoelectronic semiconductor chips that are usually illuminated during operation of the pixel array.

In one embodiment of the method of operating further includes that a power of the pixel array is reduced when the temperature calculated from the measured operation parameters of the optoelectronic semiconductor chips exceeds a temperature threshold. Therefore, damaging of the pixel array may be reduced or prevented. In one embodiment of the method of operating the power of the pixel array is reduced by means of a pulse-width-modulation or a reduction of driving current and/or driving voltage of the pixel array.

In one embodiment of the method of operating the operation model of the pixel array is stored in a memory of the driving circuit and may be read-out from that memory. The storage of the operation model may be particularly taking place when the operation model has been updated.

In one embodiment of the method of operating the operation parameter includes a current or a voltage supplied to the at least one of the optoelectronic semiconductor chips of the pixel array. Particularly, a relation between temperature and current or voltage may be used for the operation model.

In one embodiment of the method of operating a first data point is established at every starting up of the pixel array or a first data point is established at every starting up of the pixel array and a second data point is established at every turning off of the pixel array. A predefined number of first data points or a predefined number of first data points and a predefined number of second data points is used to calculate the operation model. This allows for a continuous update of the operation model during a life-span of the pixel array.

In one embodiment of the method of operating the predefined number of first data points or the predefined number of first data points and the predefined number of second data points is saved in a shifting register. This allows for an easy implementation of this method, as older data points may be shifted from the shifting register.

In one embodiment of the method of operating the at least one of the optoelectronic semiconductor chips of the pixel array is selected according to an expected illumination pattern of the pixel array.

In one embodiment of the optoelectronic component the driving circuit comprises a memory. The operation model is stored in the memory. In one embodiment of the optoelectronic component the memory comprises a shifting register. A predefined number of first data points or a predefined number of first data points and a predefined number of second data points may be stored in the shifting register.

In one embodiment of the optoelectronic component the memory is a read-only memory. In one embodiment the optoelectronic component further comprises a projection objective.

In one embodiment of the method manufacturing, the operation model is determined experimentally. The pixel array is started up and turned off several times. A first data point is established at every starting up of the pixel array or a first data point is established at every starting up of the pixel array and a second data point is established at every turning off of the pixel array. The first data points or the first data points and the second data points are used to calculate the operation model. With this method, the operation model may be established during manufacturing of the optoelectronic component.

### BRIEF DESCRIPTION OF THE DRAWINGS

The properties, features and advantages of the present invention described above, as well as the way they are achieved, become clearer and more understandable in connection with the following description of the embodiment examples, which are explained in more detail in connection with the drawings. In each case, the following examples show in a schematic representation

FIG. 1 an optoelectronic component;

FIG. 2 an illumination device;

FIG. 3 a flowchart of a method of operating an optoelectronic component;

FIG. 4 an operation model of an optoelectronic component; and

FIG. 5 a flowchart of a method of manufacturing an optoelectronic component.

### DETAILED DESCRIPTION OF ILLUSTRATIVE EMBODIMENTS

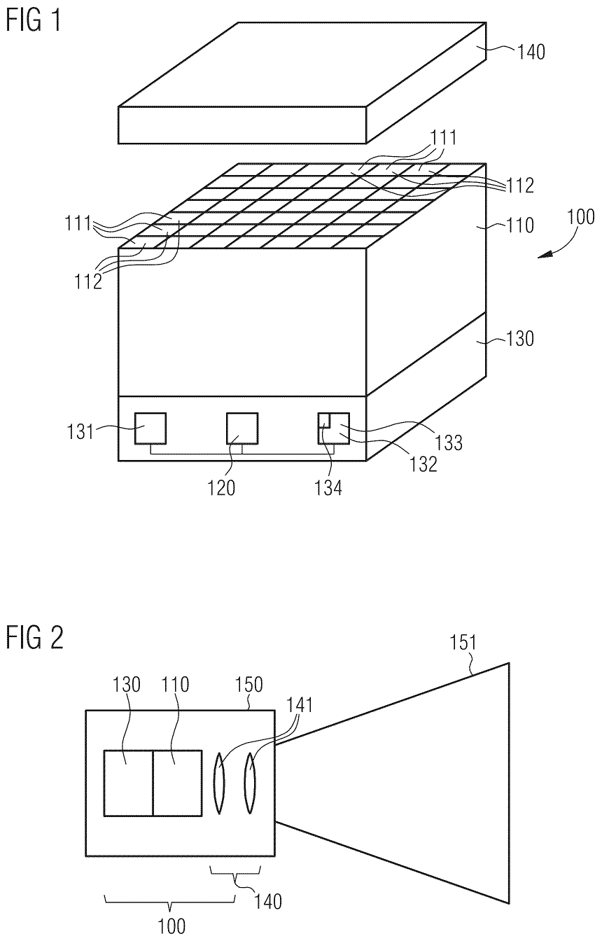

FIG. 1 shows an optoelectronic component 100 comprising a pixel array 110 with a plurality of optoelectronic semiconductor chips 111, a temperature sensor 120, and a driving circuit 130. The temperature sensor 120 is in thermal contact with the pixel array 110. The driving circuit 130 is equipped to execute a method of operating the optoelectronic component which will be explained in further detail below.

Particularly, the pixel array 110 may include a great number pixels 112 and therefore optoelectronic semiconductor chips 111. For sake of clarity, not all pixels have the reference sign 112 and not all optoelectronic semiconductor chips have the reference sign 111. The number of pixels 112 is 49 in FIG. 1, but may be around 25.000 or even greater, particularly around 50.000 or even 100.000 for an optoelectronic component 100. Furthermore, the optoelectronic component 100 may include other elements like a housing and/or a power supply, which are not shown in FIG. 1, but may be provided by a person of artisan skill. The temperature sensor 120 is shown to be a part of the driving circuit 130. However, in an embodiment not shown the temperature sensor 120 may be arranged in between the pixel array 110 and the driving circuit 130 or at the side of the pixel array 130. The driving circuit 130 may comprise a central processing unit 131 to execute method steps to operate the optoelectronic component 100.

Additionally, the driving circuit 130 may include a control for individually controlling the pixels 112 of the pixel array 110, particularly by controlling voltage, current or power of the pixels individually. This control may also be included into the processing unit 131.

The optoelectronic component 100 further comprises an optional projection objective 140. The projection objective 140 may include several projection lenses, particularly up to ten lenses, and may be used to project an image provided by the pixel array 110 to a greater area.

The pixel array 110 comprises an at least two-dimensional arrangement of optoelectronic semiconductor chips 111. In operation, the pixels 112 may be driven individually, particularly allowing for an image projected by the pixel array 110. The optoelectronic component 100 with the pixel array 110 may, for example, be used in automotive headlamps or active pixel projectors. The pixels 112 can have a uniform emission spectrum, particularly emitting white light. However, it is also possible that several pixels 112, particularly three are combined and form an RGB-emitting unit.

FIG. 2 shows an illumination device 150. The illumination device 150 comprises the optoelectronic component 100 of FIG. 1. In this embodiment, the projection objective 140 is depicted as two projection lenses 141. Additionally, a light cone 151 emitted from the illumination device 150 is shown in FIG. 2.

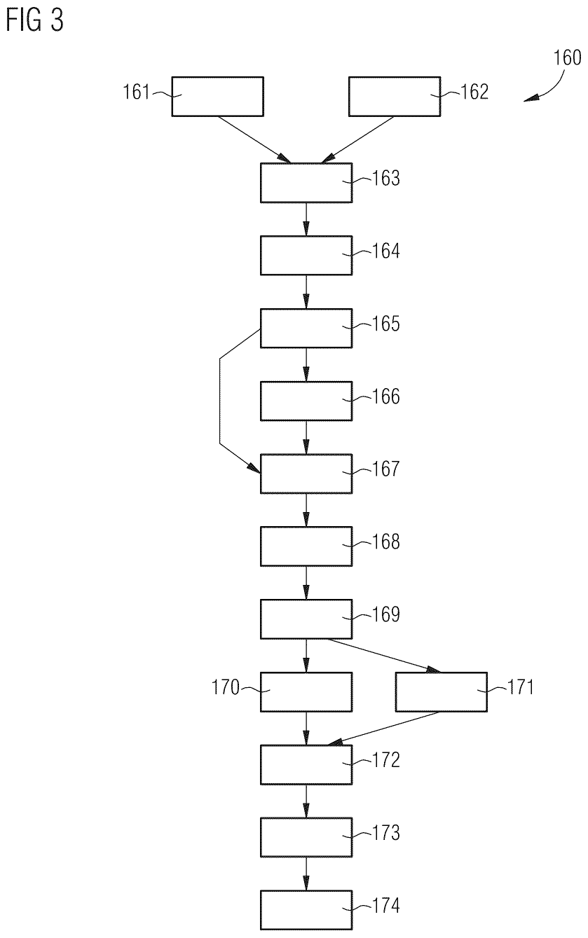

FIG. 3 shows a flowchart 160 of a method of operating the optoelectronic component 100 if FIG. 1. In a first step 161, the pixel array 110 is started up. Simultaneously to the starting up of the pixel array 110, a first temperature is read-out in a second step 162 using the temperature sensor 120. Simultaneously in this context may include within a predefined time-span, wherein the predefined time span may be some microseconds, particularly in the range of 50 microseconds, for example up to 20 microseconds. The predefined time span may be particularly chosen such that a heat generated by the semiconductor chip 111 is still so low that a temperature of a pn-junction of semiconductor chip is still unchanged. In a third step 163, a first operation parameter of at least one of the optoelectronic semiconductor chips 111 of the pixel array 110 is determined. In a subsequent fourth step 164, the first temperature and the first operation parameter are correlated to establish a first data point. As the temperature of a pn-junction of the semiconductor chip 111 is still unchanged, the first data point may include the temperature of the first pn-junction and the first operation parameter. In a fifth step 165, the operation parameter and the first temperature are compared to an operation model of the pixel array 110. If the operation parameter and the first temperature differ from the operation model by a preset first threshold, the operation model is updated in a sixth step 166. After the sixth step 166 or if the operation parameter and the first temperature differ from the operation model by less than the preset first threshold, directly after the fifth step 165, operation parameters of the optoelectronic semiconductor chips 111 of the pixel array 110 are measured and a temperature is calculated using the operation model in a seventh step 167.

The operation model may include a regression or a formula which relates the operation parameter to the temperature of the pn-junction. The core idea of the method of operating the optoelectronic component 100 is to update the operation model if the operation parameter and the first temperature differ from the operation model by a preset first threshold. If such an update has been performed, the temperature of the pn-junctions is calculated using the updated model. At every starting up of the pixel array 110, the operation model is checked and discrepancies may be considered in the operation model. Therefore, the temperature measurement of the pn-junctions is improved.

The method steps 161, 162, 163, 164, 165, 166, 167 may be executed by the driving circuit 130 and particularly by the central processing unit 131. Particularly the sixth method step 166 is defining the method according to the invention. In methods of operating optoelectronic components 100 known in the state of the art, operation models are not updated with a first data point generated at starting up the pixel array 110.

In one embodiment, the seventh step 167 is performed several times, particularly in a recurring manner. The seventh step 167 may be executed during the whole operation of the optoelectronic component 100.

In one embodiment of the method of operating, further steps as indicated in FIG. 3 are executed optionally. The pixel array 110 is turned off in an eighth step 168. After that, a preset time span is lapsed in a ninth step 169 and the method waits upon lapse of that preset time span. Then, in a tenth step 170, a second temperature is read-out using the temperature sensor 120. A second operation parameter of at least one of the optoelectronic semiconductor chips 111 of the pixel array 110 is determined in an eleventh step 171 simultaneously to the tenth step 170. Particularly, the same optoelectronic semiconductor chip 111 or the same optoelectronic semiconductor chips 111 as for the determination of the first operation parameter may be used in this step. The second temperature and the second operation parameter are correlated to establish a second data point in a twelfth step 172. The second operation parameter and the second temperature are compared to the operation model of the pixel array in a thirteenth step 173. If the operation parameter and the second temperature differ from the operation model by a preset second threshold, the operation model is updated in a fourteenth step 174. Otherwise, the operation model is not updated and the fourteenth step 174 is not executed.

The preset time span of the ninth step 169 may be set in such a way that thermal equilibrium between the temperature sensor 120 and the optoelectronic semiconductor chip 111 or the optoelectronic semiconductor chips 111 of the pixel array 110 is reached. To determine the second operation parameter, the optoelectronic semiconductor chip 111 or the optoelectronic semiconductor chips 111 may be turned on again for a short amount of time, particularly for some milliseconds. With these additions to the method the operation model may be adjusted for low temperatures using the first operation parameters and for high temperatures using the second operation parameters. Therefore, an overall operation model is improved.

In one embodiment of the method of operating the preset time span is five seconds or less, particularly three seconds or less, particularly in the range of one to two seconds. This allows for thermal equilibrium of the pn-junctions and the temperature sensor 120.

In one embodiment of the method of operating the operation model of the pixel array 110 is stored in the memory 132 of the driving circuit 130. The model may be read-out from that memory 132. In an embodiment of the optoelectronic component 100, the driving circuit 130 includes the memory 132 as shown in FIG. 1. The memory 132 may be a read-only memory 133. Alternatively, the driving circuit 130 may be equipped to read the model from an external memory, wherein the external memory is located in an external device.

In one embodiment of the method of operating the first threshold and the second threshold are identical. This allows for an improved determination of the operation model. The first threshold and/or the second threshold in all embodiments may include a temperature value. If the temperature determined by the operation model for a given operation parameter differs by more than this threshold temperature from the read out from the temperature sensor, the operation model is adjusted.

In one embodiment of the method of operating the optoelectronic semiconductor chip 111 or the optoelectronic semiconductor chips 111 of the pixel array 110 are selected according to an illumination pattern of the pixel array 110. This selection may include selection of optoelectronic semiconductor chips 111 that are usually illuminated during operation of the pixel array 110.

In one embodiment of the method of operating further includes that a power of the pixel array 110 is reduced when the temperature calculated from the measured operation parameters of the optoelectronic semiconductor chips 111 exceeds a temperature threshold. Therefore, damaging of the pixel array 110 may be reduced or prevented. In one embodiment of the method of operating the power of the pixel array 110 is reduced by means of a pulse-width-modulation or a reduction of driving current and/or driving voltage of the pixel array 110.

In one embodiment of the method of operating the operation parameter includes a current or a voltage supplied to the at least one of the optoelectronic semiconductor chips 111 of the pixel array 110. Particularly, a relation between temperature and current or voltage may be used for the operation model.

In one embodiment of the method of operating a first data point is established at every starting up of the pixel array 110 or a first data point is established at every starting up of the pixel array 110 and a second data point is established at every turning off of the pixel array 110. A predefined number of first data points or a predefined number of first data points and a predefined number of second data points is used to calculate the operation model. This allows for a continuous update of the operation model during a life-span of the pixel array.

In one embodiment of the method of operating the predefined number of first data points or the predefined number of first data points and the predefined number of second data points is saved in a shifting register 134. Such a shifting register 134 is shown in FIG. 1. This allows for an easy implementation of this method, as older data points may be shifted from the shifting register 134.

In one embodiment of the method of operating the at least one of the optoelectronic semiconductor chips 111 of the pixel array 110 is selected according to an expected illumination pattern of the pixel array 110.

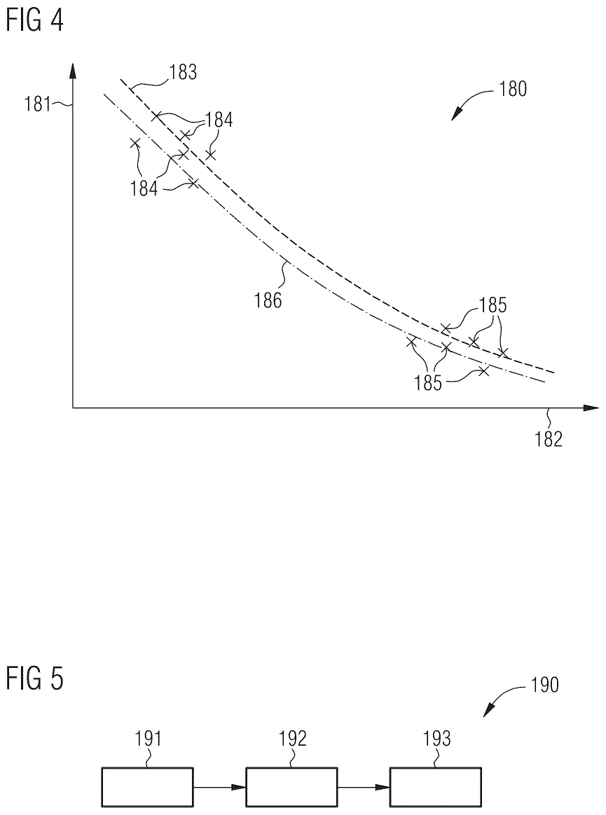

FIG. 4 shows a diagram 180 of an operation parameter 181 of an optoelectronic component 100 plotted against a temperature 182 of the optoelectronic component 100. Furthermore, an operation model 183 is included in the diagram 180 (dashed line) which allows to correlate an operation parameter 181 to a temperature 182 of the pn-junction. Several first data points 184, established when the optoelectronic component 100 is switched on, and second data points 185, established when the optoelectronic component 100 is turned off, are also depicted in the diagram 180. As the first data points 184 and the second data points 185 differ from the operation model 183, an updated operation model 186 (line dotted) is also depicted. The updated operation model 186 may be calculated using the method described with respect to FIG. 3.

The operation parameter 181 may be a forward voltage of the optoelectronic semiconductor chips 111 of the pixel array 110. In this case, the optoelectronic semiconductor chips 111 may be driven with a fixed current and the forward voltage may be linked to a temperature of a pn-junction of the optoelectronic semiconductor chips 111. Alternatively, the operation parameter 181 may be a current of the optoelectronic semiconductor chips 111 of the pixel array 110. In this case, the optoelectronic semiconductor chips 111 may be driven with a fixed voltage and the current may be linked to a temperature of a pn-junction of the optoelectronic semiconductor chips 111.

FIG. 5 shows a flowchart 190 a method of manufacturing an optoelectronic component 100. In this method, the pixel array 110, the driving circuit 130 and the temperature sensor 120 are provided in a first step 191 in such a way that the temperature sensor 120 is in thermal contact with the pixel array 110. These may be arranged in a way that the optoelectronic component 100 of FIG. 1 is formed. In a second step 192 the operation model of the pixel array 110 is established, regarding a relationship between the operation parameter and the temperature. This model is then provided for the driving circuit 130 in a third method step 193, particularly by storing the model into the memory 132.

In one embodiment of the method manufacturing, the operation model is determined experimentally. This may be done by using the method as described with respect to FIG. 4. The pixel array 110 is started up and turned off several times. A first data point 184 is established at every starting up of the pixel array 110 or a first data point 184 is established at every starting up of the pixel array 110 and a second data point 185 is established at every turning off of the pixel array 110. The first data points 184 or the first data points 184 and the second data points 185 are used to calculate the operation model. With this method, the operation model may be established during manufacturing of the optoelectronic component 100.

Although the invention has been illustrated and described in detail by means of the preferred embodiment examples, the present invention is not restricted by the disclosed examples and other variations may be derived by the skilled person without exceeding the scope of protection of the invention.

1.-20. (canceled)

21. A method for operating an optoelectronic component, wherein the optoelectronic component comprises a pixel array including a plurality of optoelectronic semiconductor chips, a temperature sensor, and a driving circuit, wherein the temperature sensor is in thermal contact with the pixel array, the method comprising:
starting up the pixel array;
reading-out a first temperature using the temperature sensor simultaneously to the starting up of the pixel array;
determining a first operation parameter of at least one of the optoelectronic semiconductor chips of the pixel array;
correlating the first temperature and the first operation parameter to establish a first data point;
comparing the operation parameter and the first temperature to an operation model of the pixel array;
updating the operation model when the operation parameter and the first temperature differ from the operation model by a preset first threshold;
measuring operation parameters of the optoelectronic semiconductor chips of the pixel array; and
calculating a temperature using the operation model.

22. The method according to claim 21, further comprising:
turning off the pixel array;
waiting for a preset time span;
reading-out a second temperature using the temperature sensor;
determining a second operation parameter of at least one of the optoelectronic semiconductor chips of the pixel array;
correlating the second temperature and the second operation parameter to establish a second data point;
comparing the second operation parameter and the second temperature to the operation model of the pixel array; and
updating the operation model when the operation parameter and the second temperature differ from the operation model by a preset second threshold.

23. The method according to claim 22, wherein the preset time span is five seconds or less.

24. The method according to claim 21, wherein the first threshold and a second threshold are identical.

25. The method according to claim 21, wherein the optoelectronic semiconductor chip or the optoelectronic semiconductor chips of the pixel array are selected according to an illumination pattern of the pixel array.

26. The method according to claim 21, further comprising reducing a power of the pixel array when the temperature calculated from the measured operation parameters of the optoelectronic semiconductor chips exceeds a temperature threshold.

27. The method according to claim 26, wherein the power of the pixel array is reduced by a pulse-width-modulation or a reduction of driving current and/or driving voltage of the pixel array.

28. The method according to claim 21, wherein the operation model of the pixel array is stored in a memory of the driving circuit and read-out from the memory.

29. The method according to claim 21, wherein the operation parameter includes a current or a voltage supplied to the at least one of the optoelectronic semiconductor chips the pixel array.

30. The method of claim 21, further comprising:
establishing the first data point at every starting up of the pixel array or establishing the first data point at every starting up of the pixel array and establishing a second data point at every turning off of the pixel array; and
using a predefined number of first data points or using a predefined number of first data points and a predefined number of second data points to calculate the operation model.

31. The method of claim 30, further comprising saving the predefined number of first data points or the predefined number of first data points and the predefined number of second data points in a shifting register.

32. The method according to claim 21, further comprising selecting the at least one of the optoelectronic semiconductor chips of the pixel array according to an expected illumination pattern of the pixel array.

33. The optoelectronic component comprising:
the pixel array;
the temperature sensor; and
the driving circuit,
wherein the temperature sensor is in thermal contact with the pixel array, and
wherein the driving circuit is configured to perform the method according to claim 21.

34. The optoelectronic component according to claim 33, wherein the driving circuit comprises a memory, wherein the operation model is stored in the memory.

35. The optoelectronic component according to claim 34, wherein the memory comprises a shifting register configured to store a predefined number of first data points or a predefined number of first data points and a predefined number of second data points.

36. The optoelectronic component according to claim 34, wherein the memory is a read-only memory.

37. The optoelectronic component according to claim 33, further comprising a projection objective.

38. An illumination device comprising:
the optoelectronic component according to claim 13.

39. A method for manufacturing the optoelectronic component according to claim 33, the method comprising:
providing the pixel array, the driving circuit and the temperature sensor, wherein the temperature sensor is in thermal contact with the pixel array;
establishing the operation model of the pixel array regarding a relationship between an operation parameter and a temperature; and
providing the operation model for the driving circuit.

40. The method according to claim 39, wherein the operation model is determined experimentally, wherein the pixel array is started up and turned off several times, wherein the first data point is established at every starting up of the pixel array or the first data point is established at every starting up of the pixel array and a second data point is established at every turning off of the pixel array, and wherein the first data points or the first data points and the second data points are used to calculate the operation model.
